(19) United States
(12) Patent Application Publication
(10) Pub. No.: US 2009/0259724 A1
(43) Pub. Date: Oct. 15, 2009

(54) METHOD OF ORGANIZING AND DISPLAYING E-MAILS

(75) Inventor: Silvana Deana, Tomas Diago (UY)

Correspondence Address: ZARLEY LAW FIRM P.L.C., CAPITAL SQUARE, 400 LOCUST, SUITE 200, DES MOINES, IA, 50309-2350, US

(73) Assignee: PAISAL S.A., MONTEVIDEO (UY)

(21) Appl. No.: 12/417,058

(22) Filed: Apr. 2, 2009

Related U.S. Application Data
(60) Provisional application No. 61/041,961, filed on Apr. 3, 2008.

(51) Int. Cl. G06F 15/16

(52) U.S. Cl. 709/206

(57) ABSTRACT

A method of organizing and displaying e-mails. The steps of the method include providing a computer having a server that receives e-mails from a remote server and providing software on the computer that collects the e-mails received by the server into an e-mail account. The next step is organizing the e-mails in the e-mail account into a plurality of groups with the software based upon a predetermined criteria determined by a user. Next, the e-mails are displayed in a group with the software when actuated by the user.

### CROSS REFERENCE TO RELATED APPLICATION

This application claims the benefit of U.S. Provisional Application No. 61/041,961 filed Apr. 3, 2008.

### BACKGROUND OF THE INVENTION

This invention relates to e-mail accounts. More specifically, this invention relates to a method of organizing and displaying e-mails within an e-mail account.

For many years e-mail accounts have been used as a result of the internet. Specifically, e-mail accounts are a collection of e-mails that are messages sent from individuals via the internet. A server sends an e-mail from a first computer and the e-mail message is received by the server by a second server and placed into an account. Software has been provided to collect and organize e-mail. Typically, as messages are received in an individual's Inbox, they are placed in chronological order. At that time an individual can read or delete an e-mail as they choose. Some software programs allow for an individual to sort the e-mail in different manners such as alphabetically or in reverse chronological order.

While these advancements in e-mail accounts have allowed individuals to access their e-mails, many problems still remain. Finding specific e-mails are oftentimes difficult wherein one must sort through many e-mails in order to find the one they desire. Additionally, e-mails typically take up a lot of memory space wherein if you copy an e-mail into different locations every copy of the e-mail takes memory space in the e-mail account wherein once the maximum amount of memory is reached an individual can no longer receive e-mails and other problems occur within the e-mail account. Additionally, problems remain in that information is not easily found and especially hard on the eyes in that everything is in written form.

Therefore, a principal object of the present invention is to provide a method of organizing and displaying e-mails that improves the organization of an e-mail account.

Yet another object of the present invention is to provide a method of organizing and displaying e-mails that is more esthetically pleasing to an individual user.

Another object of the present invention is to minimizing the amount of memory used by individual e-mails.

These and other objects, features, or advantages will become apparent from the specification and claims.

### BRIEF SUMMARY OF THE INVENTION

A method of organizing and displaying e-mails. The method includes providing a computer that has a server that receives e-mails from a remote server. Software is provided on the computer that collects the e-mails received by the server into an e-mail account. The e-mails are then organized in the e-mail account into a plurality of groups with the software based on a predetermined criteria determined by the user. The e-mails are displayed in a group with the software once actuated by the user.

### BRIEF DESCRIPTION OF THE DRAWINGS

FIG. 1 is a schematic diagram of a method of organizing and displaying e-mails;

FIG. 2 is a side elevation view of a computer screen;

FIG. 3 is a side elevation view of a computer screen;

FIG. 4 is a side elevation view of a computer screen; and

FIG. 5 is a side elevation view of a computer screen.

### DETAILED DESCRIPTION OF THE PREFERRED EMBODIMENT

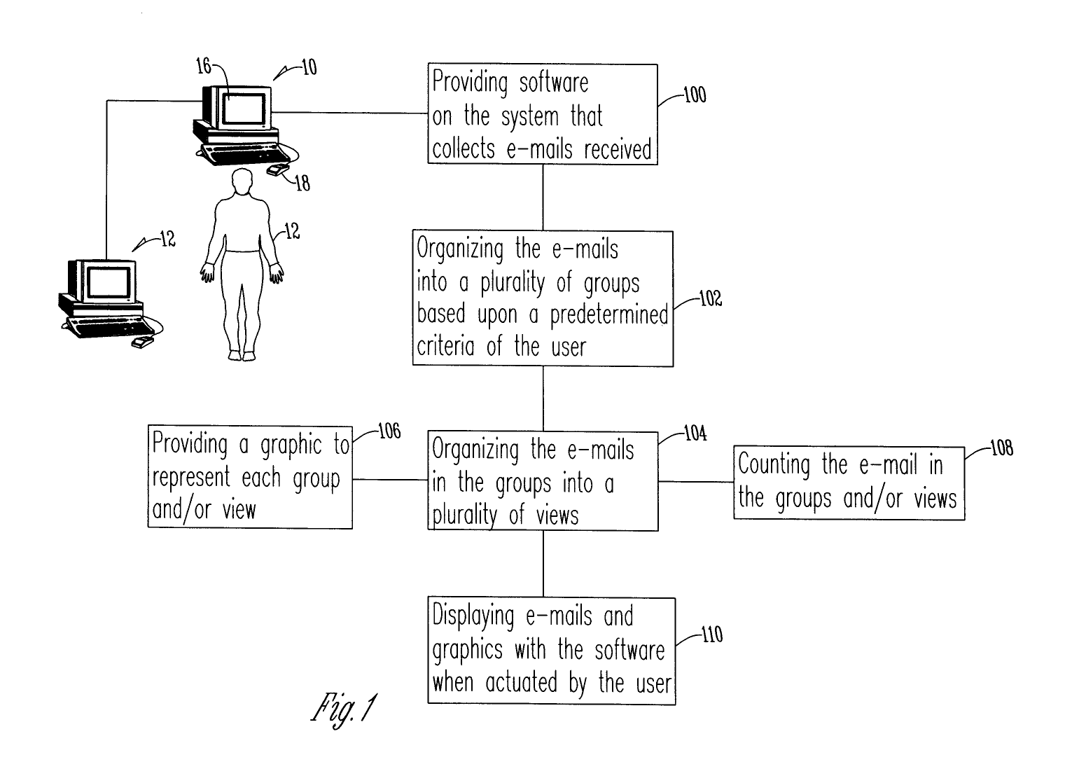

FIG. 1 provides a schematic diagram of a method of organizing and displaying e-mails. Specifically provided is a system 10 that in a preferred embodiment is a computer that can be accessed by a user 12. The computer 10 has a server that connects the system 10 to the internet as is known in the art. In this manner the system 10 is in communication with a remote system 14 that in a preferred embodiment is also a computer. The remote system 14 additionally has a server that can communicate with the server of system 10 so that e-mails can be sent from the remote system 14 to the system 10 to be displayed on screen 16. Additionally, as is known in the art, an actuating device 18 such as a mouse is used to allow a user 12 to control the system 10. While shown as a mouse 18 all input devices are contemplated by the disclosure including key pads, key boards, and the like.

The system 10 contains software that provides an e-mail account. Specifically, this e-mail account receives e-mail from remote systems 14 via the remote system server and organizes and displays the e-mails according to that desired by the user 12.

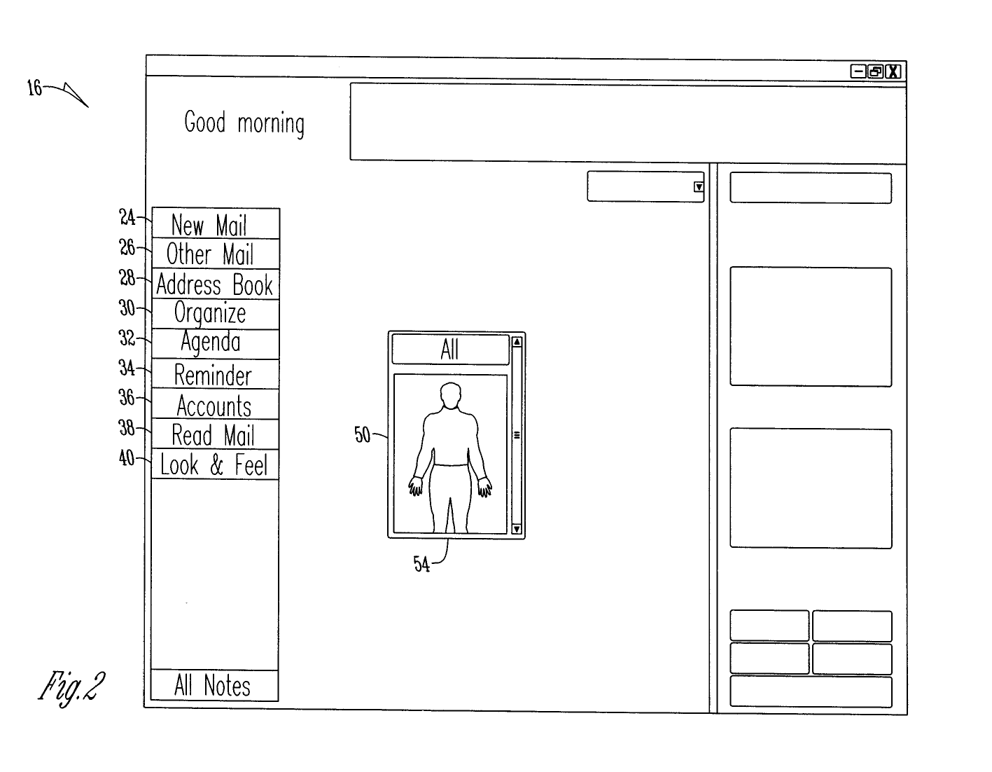

FIGS. 2-5 show the display screen 16 wherein the display screen 16 presents a plurality of different screen shots depending on how an individual desires to organize and display their e-mails. As seen in FIG. 2 when an e-mail account is originally accessed a first screen is provided that provides a plurality of buttons that represent different menus and options that can be utilized using the software provided. These buttons include new mail 24, other e-mails 26, address book 28, organize 30, agenda 32, reminder 34, accounts 36, read mail 38, and look and feel 40.

When the user 12 accesses the account, the user 12 utilizes the mouse 18 and creates an account by clicking an accounts icon and a new screen appears. The user 12 clicks the new icon and fills in the blanks including the name, e-mail address, and password. The individual also provides information regarding the outgoing server including the host (URL of outgoing mail server), server type (IMAP or POP) and PORT. The user 12 also provides information regarding the incoming server including the host (URL of incoming mail server), server type (SMTP) and port. Then the user 12 saves the data or cancels.

When a user 12 decides to edit an account data the user selects the accounts menu button 36 that shows an account view. At this point in time an individual can select the account that they desire to edit and the mouse 18 is clicked. At this time the user can change the data and the data can be saved. In order to delete an account the account is selected and a delete button is selected. Thus, multiple accounts can either be created by pressing the new button or a delete button.

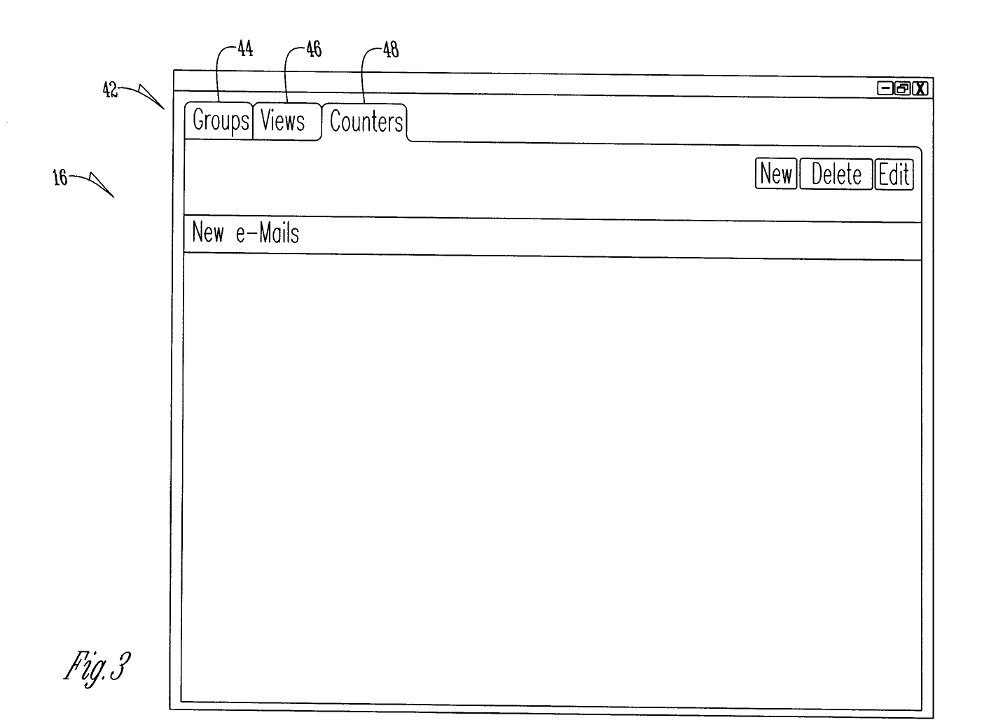

In order to organize mail a user 12 actuates the organize button 30. When actuated the screen displays a plurality of tabs 42 as best shown in FIG. 3. The tabs include a group tab 44, a views tab 46, and a counters tab 48. By using this organize function the user 12 is able to organize e-mails by subject and/or sender in a way that an e-mail is automatically classified as soon as they are downloaded into the corresponding groups 50. E-mails can be seen from different groups 50 and views 52 but there is only one e-mail. This means that there are no duplicates of the e-mail thus minimizing the amount of space the e-mail takes in the memory of the e-mail account.

A view 52 is named to the function to organize mail by categories like subjects and/or senders. Each view 52 belongs to a group 50. First, the user 12 must create a view 52 and then organize each individual views into separate groups 50. Thus, a view 52 is a subdivision inside a group 50 that the user 12 creates according to their needs and criteria. Each view 52 has a picture, image or graphic 54 selected by the user.

To create a new view 52 the user 12 goes to the main menu and clicks the organize button 30. Another frame appears in the upper left hand side allows the user 12 to click the view tab 46. At this time another frame appears wherein the user 12 is able to see all the views correspondent to a group 50 selected. If a group 50 is not yet created the user 12 can create one after creating one or more views 52.

When a user 12 decides to make a view 52 the user 12 selects a new button. This provides the option to the user to write the name of the view. At this time the user 12 provides an image wherein a load icon can be selected to provide the image or a graphic 54 desired.

The next step to creating the view is to add a “category criteria” that is done by clicking a “add” icon causing another screen to appear. On this screen the user 12 organizes e-mails according to either sender and/or subject. The sender can be taken from a list of contacts the user already has selected from a contacts available list. Similarly, a user 12 can delete a contact name if desired. If a user 12 wants to add a contact that does not already exist in the list, another “add” icon can be actuated to provide the address.

Similarly, a user 12 can organize the e-mail by subject. If a user 12 decides to organize by subject the user 12 writes one or more words that will appear as part of the subject. For example, “Friday night” and after written in a user 12 can click the “add” icon. The user 12 also can click the words and then click delete if the user 12 wants to erase the words from the subject. A “clear” button is also provided as an option to erase all the words that appear. Once completed the user 12 saves the changes and the e-mails are sorted accordingly.

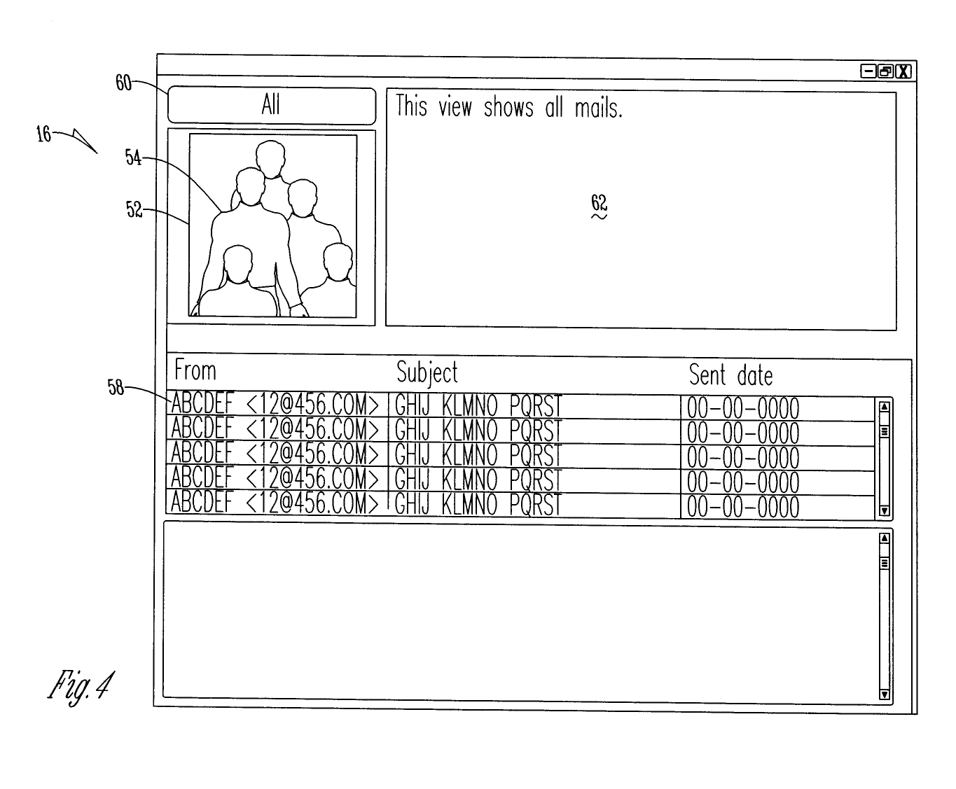

Once this is done and a view shows all mail, when a view 52 is chosen the screen shown in FIG. 4 is presented. In FIG. 4 the view is all e-mails. In this screen a mini table 58 is provided that presents all the e-mails within the account. On the top of the screen are the graphic 54 and additionally an identification box 60 including a description box 62 that presents the name and description of the mails provided in this particular view 52. While FIG. 4 shows all e-mails, if the view showed all e-mails having the subject line “BNamericas” then only those e-mails are shown in the mail table 58 wherein the identification box would say BNamericas and the description box 62 would state “this view shows all BNamericas mails.”

When the user 12 wants to edit a view the user clicks an edit icon that allows an individual to make changes to the name, image, senders, and/or subject of the view. This is similar to the steps required to add a view. Additionally, a user 12 can delete a view by selecting and pressing a delete button.

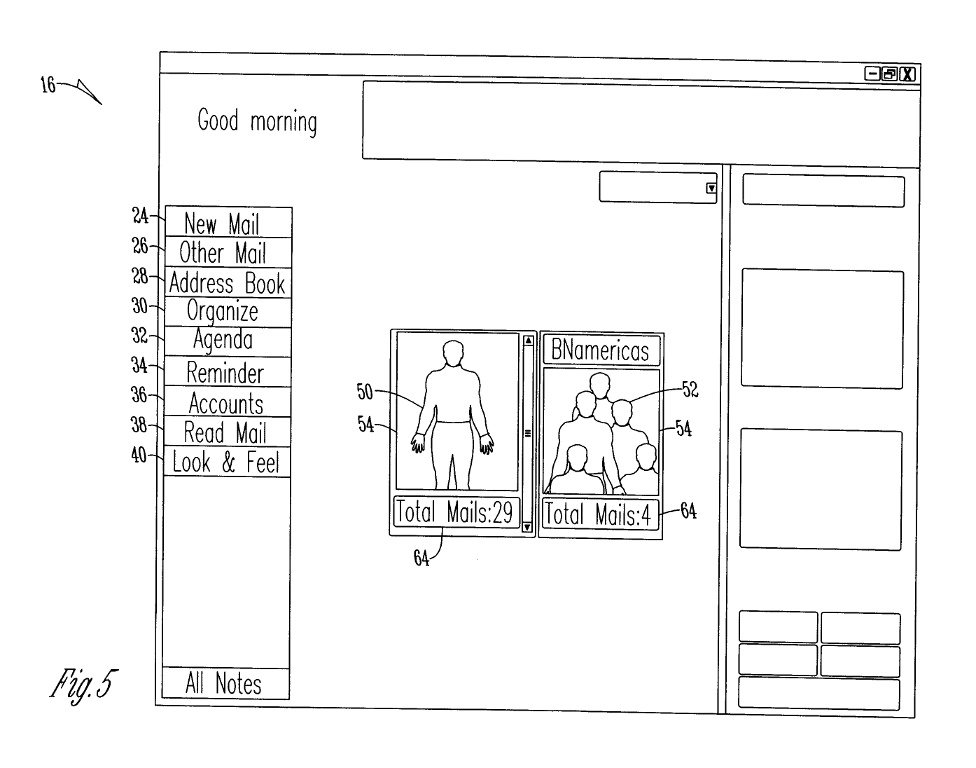

Groups 50 are one or more views that a user 12 desires to have classified. These groups are what the user first sees before editing the view. To see the groups the user has and/or to create a new group the user 12 must click the organize button or icon 30 and the different groups appear. Once one of the groups 50 is selected or clicked on the views 52 in that group are presented as shown in FIG. 5.

To create a new group the user 12 clicks on the new icon and another screen appears. In that screen the user 12 must select a new option wherein a new view can be created. At that time a name and image may be presented as previously discussed. Next, an individual chooses which groups the view is to be included. Once the individual has decided or selected all the views that must be included into the new group a save icon is clicked or actuated and the new group is created.

The main menu also has a view groups icon on the main screen that is useful to select the group the user 12 wants to see. A user 12 can click an arrow and select the group to see and shows in the main screen all of the views from the group selected.

A user 12 can also desire to know how many e-mails are in a certain view of group. Thus, provided is a counters function that causes counts 64 to be displayed in association with groups and views as shown in FIG. 5. The user 12 can have e-mails counted by three criteria: e-mail state (such as new e-mails), e-mails composition (such as sender or subject), or pending response (when a user wants to respond to an e-mail but for any reason wants to answer it later) pending response causes e-mails to be placed in a “pending response box”.

In order to use counters the user 12 must go to the organize icon 30 and click on the counters tab 48. At that time the user 12 has three options: new, delete and edit. When adding a new account an individual has the option to identify the types of mail to be counted. For example, e-mails can be counted as a result of the sender of the e-mail. Thus, from the list of contacts the user 12 has already selected the sender's e-mail address and can click the icon that looks to the frame “contacts available”. If the user wants to add a contact that is not already on the list they can do so as previously discussed. Similarly, the e-mails in the contacts list can be deleted as previously discussed.

Additionally, if a user decides that e-mails should be counted by subject the user can just write one or more words that will appear on the subject. For example, “Friday night” and afterwards click the icon to add. The user 12 can also click the words and then click delete if they desire to delete the subject matter. Similarly, there is a clear option as previously discussed.

The pending response option is where the user 12 can select if they want to answer the e-mail at a later time. In this view the counter presents how many of these unanswered e-mails are presented. Thus, an individual knows how many e-mails that they desire to respond to that they have not yet had the opportunity. The counter function is able to be edited, deleted and cleared in the same manner that views and groups are added, edited, and deleted.

The other buttons or icons presented on screen 16 include new e-mail, other e-mails, address book, agenda, reminder, read mails, and look and feel. These buttons or icons allow an individual to compose a new e-mail, look at other e-mails, view an address book, review an agenda, review a reminder, read e-mails, or consider the look and feel of the system. Regarding these buttons such as the agenda and the address book, when actuated an individual can add, edit, or delete information from an agenda or address book similar to the manner in which information is added and deleted regarding previous functions. Similarly, reading an e-mail is done in a conventional manner. With this said, by using the present system an individual that has multiple accounts when selecting the from function can send the same e-mail from multiple accounts. The e-mailing function also has other functions such as to, cc, bcc, send, and cancel that are traditional with e-mail accounts.

A final option that the system has is a corporate message. A corporate message is a mail whose contact is shown on the top right hand corner of the main menu. The corporate message by default is a corporate message. Thus, corporate messages can be received by a user.

In operation, the system 10 is provided software that collects e-mails that are received at step 100. At step 102 the software organizes the e-mails into a plurality of groups based upon a predetermined criteria of the user. At this time the software organizes the e-mail in the groups into a plurality of views at step 104. Then at steps 106 and 108 a graphic is provided to represent each group or view and the e-mails in each of the groups or views is counted. At this time at step 110 the e-mails and graphics are displayed with the software when actuated by the user.

Thus, provided is a new e-mail software that evolves the concept of seeing and organizing e-mails. Additionally, the software presents a more esthetically pleasing appearance and tells the user what they need to know about each e-mail. In a preferred embodiment the software is in a Java language though can be presented in other languages and is also adaptable as an e-mail server for internet accounts. The advantages include organizing e-mails according to a users' needs and criteria that can be changed as many times as desired by the user. Additionally, memory space is important wherein the e-mails can be read from many different screens at the same time without using the memory space of the e-mail accounts. Specifically, many things are interrelated and therefore e-mails can be interrelated and be in different categories and folders or views that are related to topic, sender, date, and the like. Thus, presented is a personal program adapted to each user's needs that is also ideal for companies. Consequently, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A method of organizing and displaying e-mails steps comprising:
providing a computer having a server that receives e-mails from a remote server;
providing software on the computer that collects the e-mails received by the server into an e-mail account
organizing the e-mails in the e-mail account into a plurality of groups with the software based upon predetermined criteria determined by a user; and
displaying e-mails in a group with the software when actuated by the user.

2. The method of claim 1 wherein a single e-mail is in more than one group.

3. The method of claim 2 wherein the single e-mail in more than one group takes the same memory space in the e-mail account as the single e-mail when the single e-mail is in only one group.

4. The method of claim 1 wherein the group is represented by a graphic when displayed.

5. The method of claim 1 wherein the predetermined criteria is a word in an e-mail subject line.

6. The method of claim 1 wherein the predetermined criteria is a name of an e-mail sender.

7. The method of claim 1 further comprising the step of making a plurality of views within each group.

8. The method of claim 7 further comprising the step of counting the e-mails within a view with the software and displaying a count for the user.

9. The method of claim 7 further comprising the step of counting the e-mails within a group with the software and displaying a count for the user.
